(19) United States
(12) Patent Application Publication
(10) Pub. No.: US 2010/0012724 A1
(43) Pub. Date: Jan. 21, 2010

(54) RF SECURITY APPARATUS AND METHOD

(76) Inventors: Ying-Cheng Yang, Taichung Hsien (TW); Chin-Huang Chen, Taichung Hsien (TW)

Correspondence Address: APEX JURIS, PLLC, 12733 LAKE CITY WAY NORTHEAST, SEATTLE, WA, 98125, US

(21) Appl. No.: 12/253,200

(22) Filed: Oct. 16, 2008

(30) Foreign Application Priority Data
Jul. 17, 2008 (TW) 097127058

(51) Int. Cl. G06K 7/08; G06F 12/02

(52) U.S. Cl. 235/449; 711/103

(57) ABSTRACT

The present invention is related to a RF security apparatus and method. The method includes steps of: preparing an electronic card having a circuit loop and a signal storage unit, which at least has one code signal; providing a reader for cooperating with the electronic card, wherein the reader has a sensing unit and a logic circuit, and through a wireless transmission between the circuit loop and the sensing unit, the logic circuit performs a comparison of the preset code signal; and connecting to a flash drive through the reader, wherein electronic data contained in the flash drive is accessible only after the comparison between the reader and the electronic card is performed.

### FIELD OF THE INVENTION

The present invention is related to an electronic data security system, and more particularly to a RF security apparatus and method.

### BACKGROUND OF THE INVENTION

Technology makes electronic commerce more and more common. On one hand, business presentation and discussion become to use electronic display, and on the other hand, lots of data are stored without paper so as to directly reduce the felling of trees. When discussing business via computer, in addition to considering the operation convenience for data access and presentation, such as the capacity of flash memory or hard disk, data security is also important. Therefore, electronic products should give consideration to both sides, so as to show the respect to the client. In the past, usually, the method for keeping security is to input code for identifying the user so as to protect the privacy. However, if the user owns more than one electronic product, he/she might need to remember multiple sets of codes, which is very inconvenient. Besides, most electronic products only use one set of code, so that the protection actually is not sufficient, and if the user lost the electronic product or code, then the privacy and the important data might easily be stolen in a very short time. Therefore, the conventional way is not only inconvenient but also insecure.

### SUMMARY OF THE INVENTION

Consequently, the object of the present invention is to provide a RF method by cooperating an electronic card with a RF reader, so that not only the user does not need to memorize the code but the data privacy also can be protected.

The apparatus according to the present invention includes an electronic card, a RF reader and a flash drive. The electronic card contains a circuit loop and a signal storage unit, which at least has a code signal. The RF reader has a sensing unit, a filter unit, and a RF logic circuit, wherein the RF logic circuit compares the code signal through the wireless transmission between the electronic card and the sensing unit.

The flash drive contains an accommodating space and an opening, wherein the accommodating space has a memory microprocessor and the RF reader which are connected together. The memory microprocessor includes a connecting port located at the opening for plugging into a slot on the computer so as to transmit electronic data.

A RF security method according to the present invention includes steps of: preparing an electronic card having a circuit loop and a signal storage unit, which has at least a code signal preset therein, providing a reader for cooperating with the electronic card, wherein the reader has a sensing unit and a logic circuit, and through a wireless transmission between the circuit loop and the sensing unit, the logic circuit performs a comparison of the preset code signal, and connecting to a flash drive through the reader, wherein electronic data contained in the flash drive is accessible only after the comparison of the code signal between the reader and the electronic card is performed.

Accordingly, the purpose of protecting secret electronic data can be achieved, and further, the user does not need to memorize the code since the code comparison is automatically achieved through the RF system, which provides not only privacy but also convenience.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing a RF security apparatus according to the present invention;

FIG. 2 is a schematic view showing a RF security apparatus according to the present invention;

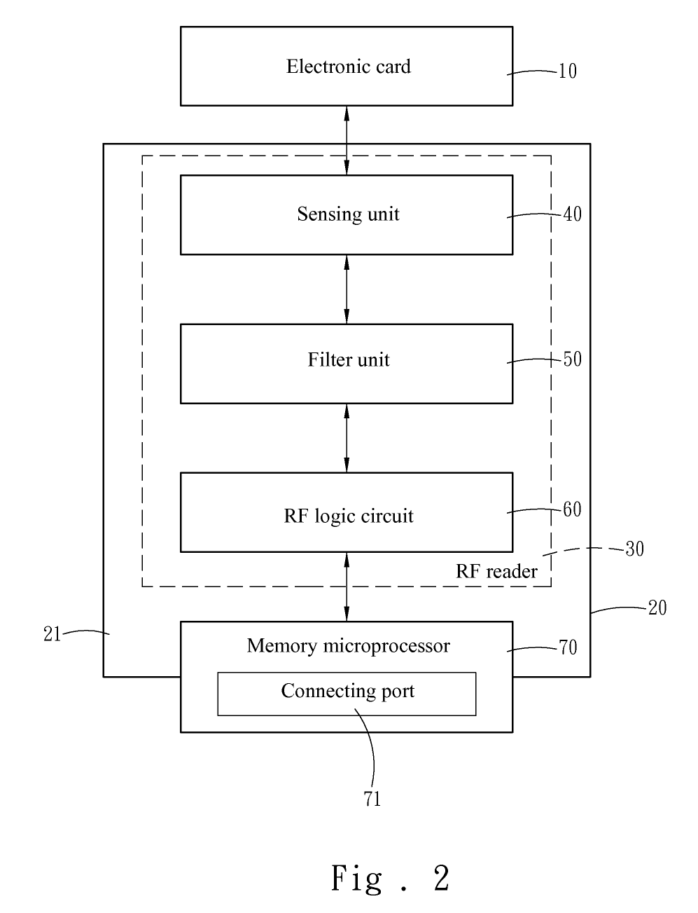

FIG. 3 is a circuit block showing a RF security apparatus according to the present invention; and

FIG. 4 is a flow chart showing a RF security method according to the present invention.

### DESCRIPTION OF THE PREFERRED EMBODIMENT

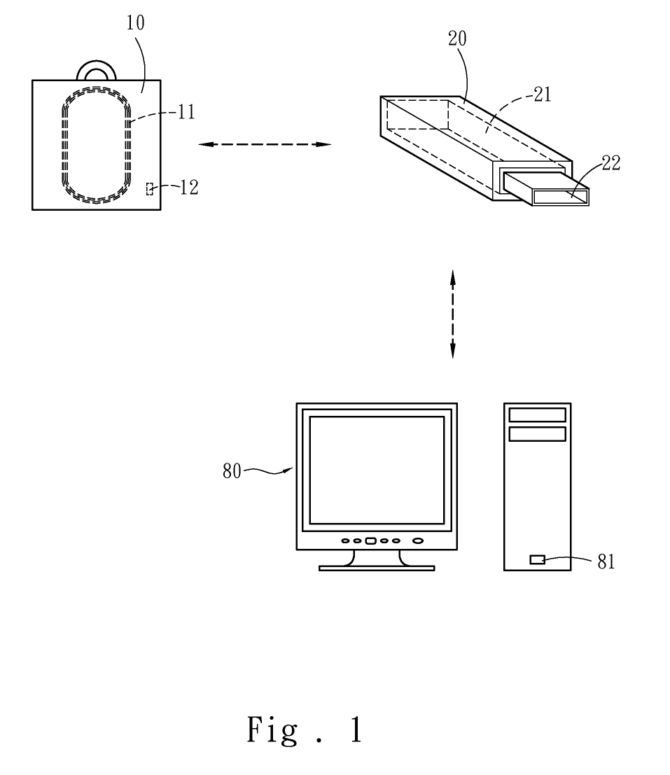

Please refer to FIGS. 1˜3. A RF security apparatus includes an electronic card 10, a RF reader 30, and a flash drive 20. The electronic card 10 contains a circuit loop 11 and a signal storage unit 12. In the electronic card 10, at least a code signal (not shown in the drawings) is preset for cooperating with the RF reader 30. The RF reader 30 contains a sensing unit 40, a filter unit 50, and a RF logic circuit 60, wherein the filter unit 50 is respectively connected with the sensing unit 40 and the RF logic circuit 60, and the filter unit 50 is used to filter the signals transmitted between the sensing unit 40 and the RF logic circuit 60. A code signal is wirelessly transmitted from the circuit loop 11 to the sensing unit 40, and the code signal is compared by the RF logic circuit 60.

The flash drive 20 includes an accommodating space 21 and an opening 22, wherein the accommodating space 21 contains the RF reader 30 and a memory microprocessor 70 which is connected with the RF reader 30, and the memory microprocessor 70 includes a connecting port 71 located at the opening 22. Therefore, only after the code signal is compared between the RF reader 30 and the electronic card 10, the data stored in the flash drive 20 can be accessed through the connecting port 71 plugging into a slot 81 on a computer 80.

Here, the electronic card 10 can be applied as an identification card, a magnetic card, or a key ring, and the code set in the signal storage unit 12 and the RF logic circuit 60 can have one default set and two user sets, wherein the default set code can not be changed, and two user set codes can be altered by the user as needed so as to enhance protection efficiency and improve security of electronic data.

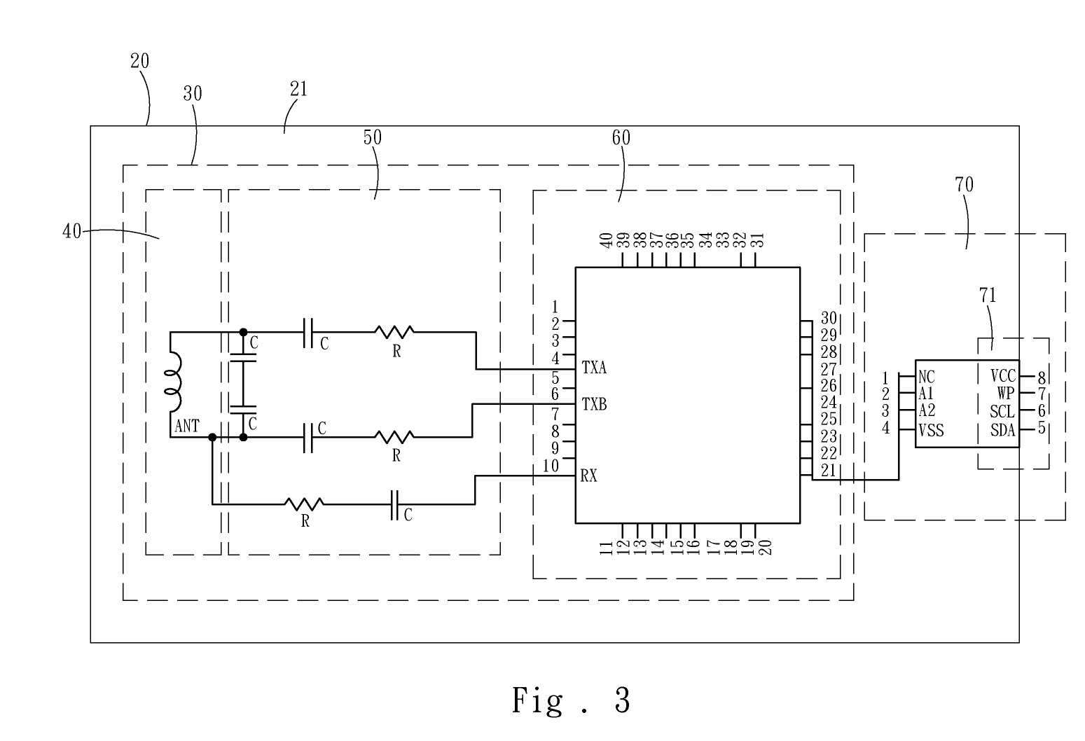

Please refer to FIG. 3. The sensing unit 40 contains a sensing antenna (ANT) for wirelessly transmitting the code signal, and then the code signal is transmitted to the filter unit 50, which is connected with the sensing unit 40, for filtering. In the filter unit 50, there are multiple filter capacitors (C) for filtering noises. Then, the RF logic circuit 60, which is connected with the filter unit 50, performs the comparison of the code signal. Finally, if the result matches, the computer 80 can access the data in the flash drive 20 through the connection with the connecting port 71.

The transmission method for the code signal is described below. The electronic card 10 actively transmits the code signal to the sensing antenna (ANT). The sensing antenna (ANT) receives the code signal and transmits it to a receiving terminal (RX) of the RF logic circuit 60. Then, the RF logic circuit 60 performs the comparison. Alternatively, the RF logic circuit 60 actively outputs electric waves to the electronic card 10 through two transmitting terminals (TXA, TXB) and the sensing antenna (ANT). Then, the circuit loop 11 in the electronic card 10 transforms the electric wave into electric energy for operating the circuit inside the electronic card 10, so that the electronic card 10 can transmit the code signal back to the RF logic circuit 60 for performing the comparison.

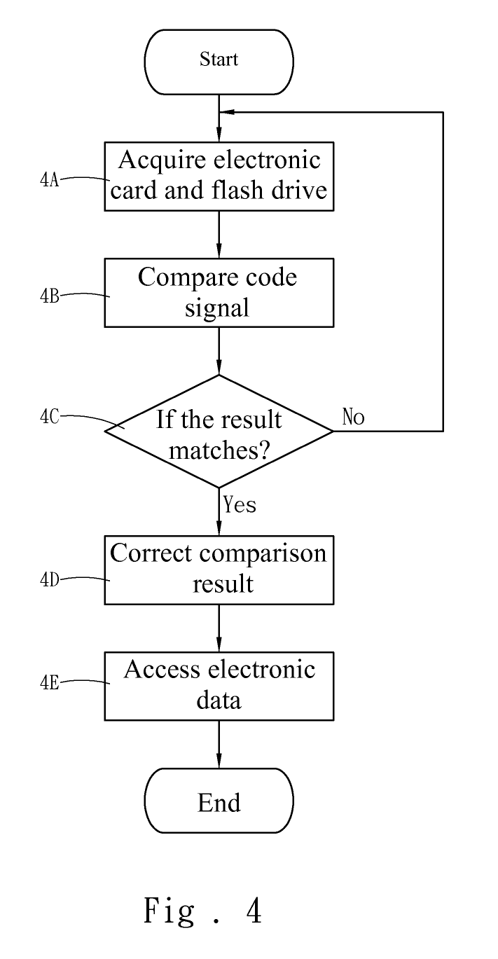

Please also refer to FIG. 4. At the beginning, the user has to simultaneously acquire the electronic card 10 and the flash drive 20 (step 4A), and then, the code signal is compared by the RF logic circuit 60 in the flash drive 20 (step 4B) to judge if the result matches (step 4C). When the result shows unmatched, the user has to again confirm that if the electronic card 10 and the flash drive 20 belong to one identical user. Therefore, only as the comparison of the code signal is correct (step 4D), the computer 80 can access the electronic data in the flash drive 20 through the slot 81 and the connecting port 71 (step 4E). Therefore, the IFF (Identification Friend or Foe) technology used in national defense and the RFID (Radio Frequency Identification) system used in retail business can be applied to personal privacy protection or electronic data security.

Accordingly, through the code signal comparison between the electronic card 10 and the RF reader 30, the electronic data stored in the flash drive 20 can be protected, and in addition to data security, it is convenient that the user does not need to memorize the code since the RF apparatus can directly and wirelessly perform code comparison, and it also confirms to environmental consciousness by reducing paper usage and the burden on earth.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A RF security apparatus, comprising:
an electronic card, containing a circuit loop and a signal storage unit, which at least has one code signal;
a RF reader, having a sensing unit, a filter unit, and a RF logic circuit, wherein the RF logic circuit compares the code signal through the wireless transmission between the circuit loop and the sensing unit; and
a flash drive, having an accommodating space and an opening, wherein the accommodating space contains a memory microprocessor and the RF reader which are connected together.

2. The RF security apparatus as claimed in claim 1, wherein the electronic card is an identification card, a magnetic card or a key ring.

3. The RF security apparatus as claimed in claim 1, wherein the filter unit is connected with the sensing unit and the RF logic circuit.

4. The RF security apparatus as claimed in claim 1, wherein the memory microprocessor includes a connecting port located at the opening for providing a connection for the flash drive to a slot on a computer.

5. A RF security method, comprising steps of:
preparing an electronic card having a circuit loop and a signal storage unit, wherein the signal storage unit has at least one code signal preset therein, and the code signal is transmitted through the circuit loop;
providing a reader for cooperating with the electronic card, wherein the reader has a sensing unit and a logic circuit, and through a wireless transmission between the circuit loop and the sensing unit, the logic circuit performs a comparison of the preset code signal; and
connecting to a flash drive through the reader, wherein electronic data contained in the flash drive is accessible only after the comparison between the reader and the electronic card is performed.

6. The method as claimed in claim 5, wherein the electronic card is an identification card, a magnetic card, or a key ring.
